(19) United States
(12) Patent Application Publication
(10) Pub. No.: US 2011/0224934 A1
(43) Pub. Date: Sep. 15, 2011

(54) EVALUATING APPARATUS, EVALUATING METHOD, AND COMPUTER PROGRAM PRODUCT

(76) Inventors: Seiro Miyoshi, Aichi (JP); Hideaki Abe, Kanagawa (JP); Kazuhiro Takahata, Kanagawa (JP); Masafumi Asano, Kanagawa (JP); Shoji Mimotogi, Kanagawa (JP); Tomoko Ojima, Tokyo (JP); Masanari Kajiwara, Kanagawa (JP)

(21) Appl. No.: 12/882,998

(22) Filed: Sep. 15, 2010

(30) Foreign Application Priority Data
Mar. 15, 2010 (JP) 2010-058303

(51) Int. Cl. G06F 19/00

(52) U.S. Cl. 702/82

(57) ABSTRACT

According to one embodiment, an evaluating apparatus includes a resist-pattern-data acquiring unit and an evaluating unit. The resist-pattern-data acquiring unit acquires resist pattern data having a plurality of feature values including at least two among a hole diameter measured concerning a pattern for hole formation in the resist pattern, an aspect ratio of the hole diameter, and a difference of hole diameters at a plurality of signal thresholds. The evaluating unit calculates an evaluation value using an evaluation function for evaluating whether a hole pattern formed on a processing target by using the pattern for hole formation is unopened and the resist pattern data and evaluates presence or absence of a risk that the hole pattern is unopened.

### CROSS-REFERENCE TO RELATED APPLICATIONS

This application is based upon and claims the benefit of priority from the prior Japanese Patent Application No. 2010-058303, filed on Mar. 15, 2010; the entire contents of which are incorporated herein by reference.

### FIELD

Embodiments described herein relate generally to an evaluating apparatus, an evaluating method, and a computer program product.

### BACKGROUND

In general, in manufacturing of a semiconductor device, a resist is applied on a semiconductor substrate or a processing target such as a film formed on the semiconductor substrate and, after the resist is exposed and developed to form a resist pattern having a predetermined shape, the processing target is etched with the resist pattern as a mask. When the resist pattern is not appropriate, a hole pattern that pierces through an interlayer insulating film cannot be formed during etching. When it is found after the etching that the hole pattern is unopened, the semiconductor substrate cannot be reused and discarded. Therefore, a method for inspecting, at the stage of the formation of the resist pattern, whether the resist pattern is appropriate to process the processing target is proposed (see, for example, Japanese Patent Application Laid-Open No. 2000-269112).

In Japanese Patent Application Laid-Open No. 2000-269112, an exposure condition is changed to under, center, and over and a focus condition is changed to minus, center, and plus to form a resist pattern including various hole patterns and a sectional shape of the resist pattern is measured by a dimension measuring apparatus to obtain a signal waveform. A correlation ratio between the signal form and a quadratic approximate curve of the signal waveform is calculated making use of the phenomenon that, when the sectional shape is abnormal, the signal waveform changes to a parabolic shape. Inspection of non-defectiveness or defectiveness of the resist pattern is performed by using the correlation ratio.

In Japanese Patent Application Laid-Open No. 2000-269112, the sectional shape is measure by the dimension measuring apparatus. However, section samples are not produced and observed in forming positions of the hole patterns. Instead, the upper surfaces of the hole patterns are observed by a scanning electron microscope to obtain a sectional shape. Therefore, in general, it is difficult to obtain an accurate sectional shape with such a method.

### BRIEF DESCRIPTION OF THE DRAWINGS

FIGS. 1A to 1F are schematic sectional views of an example of a procedure for forming hole patterns;

FIG. 2 is a diagram of tracing of an example of an FEM image;

FIG. 3 is a diagram of tracing of a scanning electron microscope photograph indicating a state of a film to be processed after processing;

FIG. 4 is a diagram of a relation between an opening diameter of a pattern for hole formation of a resist and presence or absence of unopened hole patterns formed on the film to be processed;

FIG. 5 is a schematic block diagram of the configuration of an evaluating apparatus according to a first embodiment;

FIG. 6 is a flowchart for explaining an example of a procedure of a method of deriving an evaluation function according to the first embodiment;

FIG. 7 is a diagram of an example of a hole diameter th50;

FIG. 8 is a diagram of an example of feature values acquired for respective holes;

FIG. 9 is a diagram for explaining a concept of discrimination analysis in the case of two variables;

FIG. 10 is a diagram of an example of a matrix scatter diagram created with two feature values shown in FIG. 8;

FIG. 11 is a diagram of an example of a result of discrimination analysis between the feature values and presence or absence of unopened hole patterns of the film to be processed;

FIG. 12 is a diagram of an example of a result of the discrimination analysis;

FIG. 13 is a flowchart for explaining an example of a procedure of a method of evaluating a resist pattern according to the first embodiment;

FIGS. 14A and 14B are diagrams for explaining an example of a method of obtaining an exposure condition from an evaluation function; and

FIG. 15 is a schematic block diagram of an example of the configuration of an evaluating apparatus according to a third embodiment.

### DETAILED DESCRIPTION

In general, according to one embodiment, an evaluating apparatus is provided that evaluates, when a processing target is processed by using a resist pattern formed on the processing target, presence or absence of a risk that a hole pattern formed on the processing target is unopened. The evaluating apparatus includes a resist-pattern-data acquiring unit and an evaluating unit. The resist-pattern-data acquiring unit acquires resist pattern data having a plurality of feature values including at least two among a hole diameter at a predetermined signal threshold measured concerning a pattern for hole formation in the resist pattern, an aspect ratio of the hole diameter, and a difference of hole diameters at a plurality of signal thresholds. The evaluating unit substitutes the acquired resist pattern data in parameters of an evaluation function, which includes the feature values as the parameters, for evaluating the presence or absence of the risk that the hole pattern formed on the processing target by using the pattern for hole formation is unopened, calculates an evaluation value concerning the pattern for hole formation, and evaluates, based on the evaluation value, the presence or absence of the risk that the hole pattern is unopened.

Exemplary embodiments of an evaluating apparatus, an evaluating method, and a computer program product will be explained below in detail with reference to the accompanying drawings. The present invention is not limited to the following embodiments. Sectional views of a semiconductor device used in the embodiments are schematic. A relation between the thickness and the width of a layer, a ratio of the thicknesses of layers, and the like are different from actual ones. Film thickness explained below is an example and actual film thickness is not limited to this. In the following explanation, a general evaluating method at a stage of a resist pattern is explained and then evaluating apparatuses and evaluating methods according to embodiments are explained.

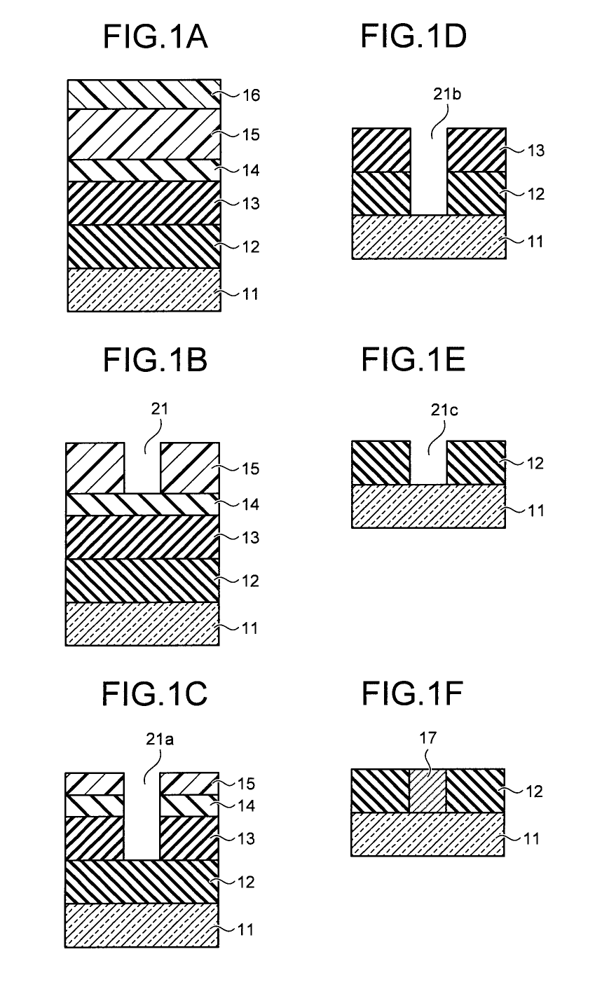

In an example explained below, hole patterns are formed on a film to be processed. FIGS. 1A to 1F are schematic sectional views of an example of a procedure for forming hole patterns. First, as shown in FIG. 1A, a film to be processed 12 formed of a silicon oxide film having thickness of 200 nanometers, a hard mask film 13 formed of an amorphous carbon film having thickness of 200 nanometers, an antireflection film 14 also serving as an upper layer hard mask having thickness of 35 nanometers, a resist 15 having thickness of 130 nanometers, and a top coat film 16 having thickness of 90 nanometers are formed in order on a wafer (a substrate) 11 such as a silicon substrate. Subsequently, the wafer 11 is selectively exposed to ArF light (having wavelength of 193.3 nanometers) through a photomask. At this point, for example, one of a dose and a value of focus in the wafer 11 is changed in a longitudinal direction and the other is changed in a lateral direction. Consequently, a wafer called “Focus-Exposure-Matrix” (hereinafter, “FEM”) is manufactured. Such exposure is performed to fluctuate a feature value of a pattern for hole formation explained later.

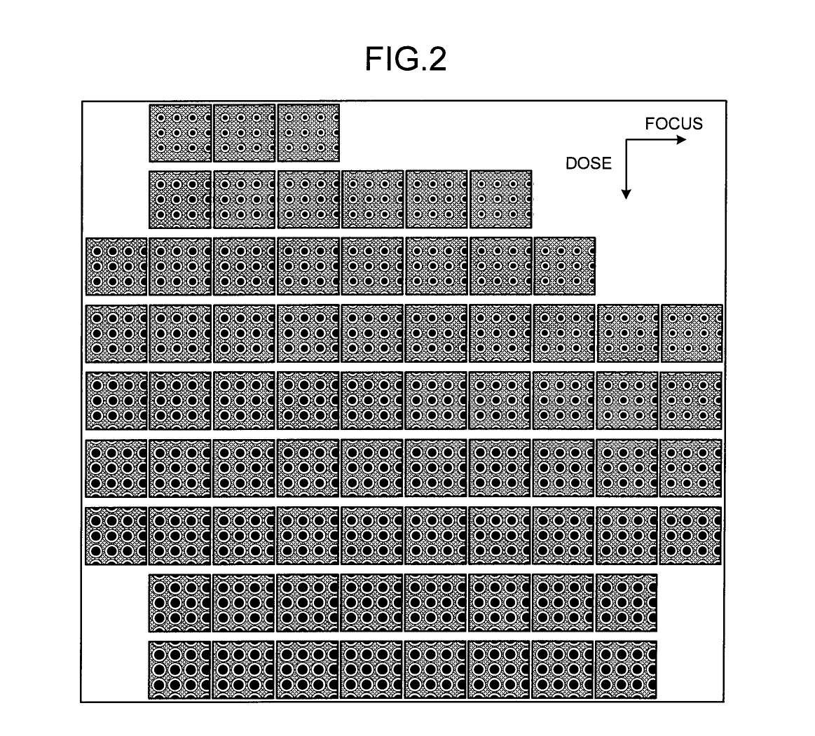

As shown in FIG. 1B, development is performed to form a predetermined pattern on the resist 15. It is assumed that a pattern for hole formation 21 is formed. FIG. 2 is a diagram of tracing of an example of an FEM image. In this example, a focus is changed in the left to right direction on the paper surface and a dose is changed in the up to down direction on the paper surface. Rectangles in the FEM image indicate shot areas exposed at a certain dose and a certain value of focus. The shot areas designated by a combination of the dose and the focus are also referred to as dose focus points below.

As shown in FIG. 1C, a hole pattern 21a is formed in the antireflection film 14 and the hard mask film 13 by the reactive ion etching (RIE) method with the resist 15 as a mask. As shown in FIG. 1D, the film to be processed 12 is processed by the RIE method with the hard mask film 13 as a mask to form a hole pattern 21b. As shown in FIG. 1E, the hard mask film 13 is removed and a hole pattern 21c is formed on the film to be processed 12. As shown in FIG. 1F, a metal film is buried in the hole pattern 21c of the film to be processed 12 to form a contact 17. The processing ends.

When the hole pattern 21c formed on the film to be processed 12 does not pierce through the film to be processed 12 and is unopened, a lower part of the contact 17 cannot be connected to the wafer 11. As a result, a connection failure occurs and cannot be remedied. Therefore, there is a method of determining, at the point when the pattern for hole formation 21 shown in FIG. 1B is formed in the resist 15, whether such unopened hole pattern 21c occurs. As a general method of determining whether the hole pattern 21c can be formed on the film to be processed 12 by the pattern for hole formation 21 formed in the resist 15, there is a method of using an opening diameter of the pattern for hole formation 21 of the resist 15.

The opening diameter of the pattern for hole formation 21 of the resist 15 is measured by using a critical dimension scanning electron microscope (CD-SEM) after the resist 15 is developed as shown in FIG. 1B. It is possible to determine, for example, after forming the hole pattern 21c on the film to be processed 12 as shown in FIG. 1E, by measuring the hole pattern 21c using the CD-SEM, whether the hole pattern 21c formed on the film to be processed 12 is unopened. Besides, the unopened hole pattern 21c can also be checked by a method of irradiating, in a state in which the contact 17 is formed as shown in FIG. 1F, an electron beam on the contact 17 and monitoring a signal of the returning electron beam, i.e., a voltage contrast method (hereinafter, “VC method”).

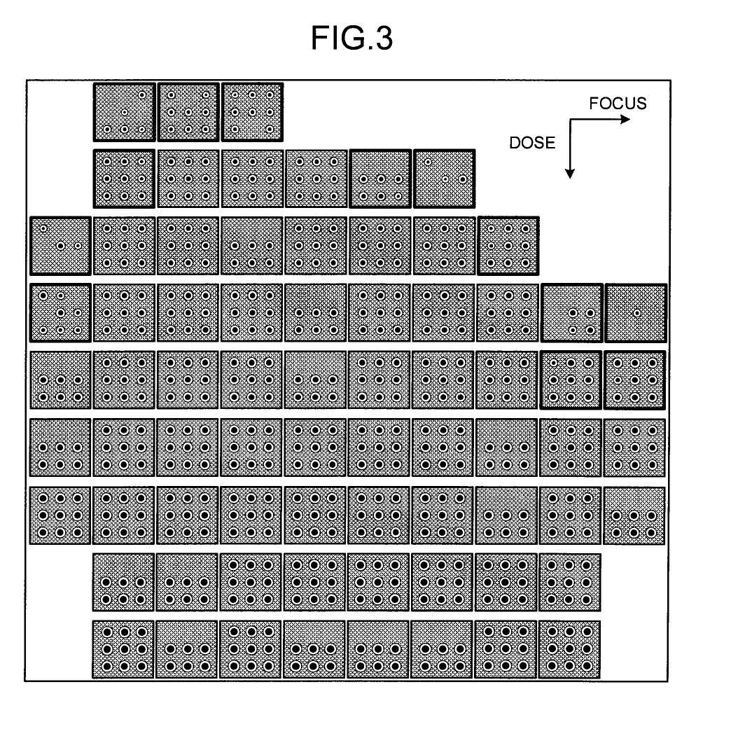

FIG. 3 is a diagram of tracing of a scanning electron microscope photograph indicating a state of a film to be processed after processing. In FIG. 3, shot areas in which un-opened hole patterns are formed are surrounded by thick lines. There are areas in which un-opened hole patterns are formed other than the shot areas surrounded by the thick lines. However, the areas are areas in which hole patterns cannot be formed at edges of a shot.

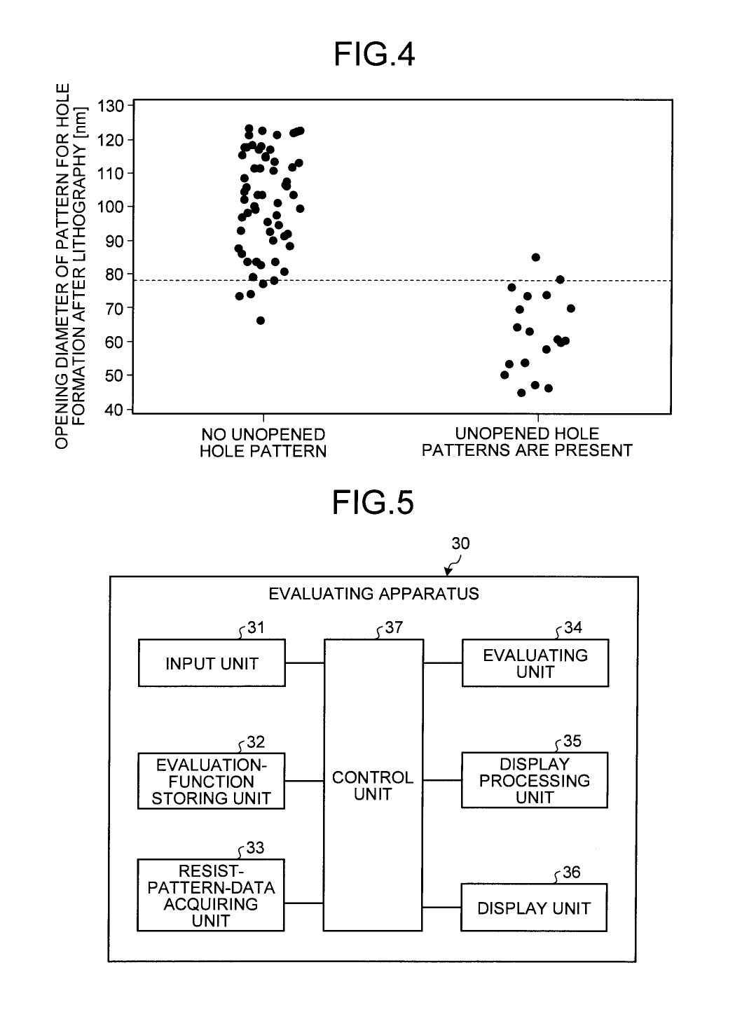

FIG. 4 is a diagram of a relation between an opening diameter of a pattern for hole formation of a resist and unopened or opened hole patterns formed on the film to be processed. In the figure, the abscissa indicates whether hole patterns 21c formed on the film to be processed 12 are unopened. The ordinate indicates an opening diameter (nm) of patterns for hole formation 21 of the resist 15. As shown in this figure, when the opening diameter of the patterns for hole formation 21 of the resist 15 is equal to or larger than 78 nanometers, most of the hole patterns 21c on the film to be processed 12 are opened. When the opening diameter is smaller than 78 nanometers, most of the hole patterns 21c are unopened. However, even when the opening diameter of the patterns for hole formation 21 of the resist 15 is equal to or larger than 78 nanometers, there are some hole patterns 21c that are unopened. Conversely, even when the opening diameter of the patterns for hole formation 21 of the resist 15 is smaller than 78 nanometers, there are some hole patterns 21c that are opened.

Therefore, it is impossible to accurately determine, according to only the opening diameter of the patterns for hole formation 21 of the resist 15, whether the hole patterns 21c formed on the film to be processed 12 are unopened. In other words, an accurate correlation cannot be established between the opening diameter of the patterns for hole formation 21 of the resist 15 and the presence or absence of the unopened hole patterns 21c of the film to be processed 12 after processing. This is considered to be because it is difficult to appropriately evaluate a taper of a sectional shape of the patterns for hole formation 21 of the resist 15. As a result, the unopened hole patterns 21c of the film to be processed 12 cannot be predicted at the stage after the development of the resist 15. If, after the processing of the hole patterns 21c on the film to be processed 12 or in the processing for burying the contact 17, it is found for the first time that the hole patterns 21c formed on the film to be processed 12 are unopened, the wafer 11 cannot be manufactured again and is lost. Therefore, it is important to reduce, at as an early stage as possible (i.e., after the development of the resist 15 and before the processing of the film to be processed 12), the risk of the unopened hole patterns 21c formed on the film to be processed 12. There is a demand for a method of evaluating at higher accuracy whether the hole patterns 21c formed on the film to be processed 12 are unopened.

An evaluating apparatus and an evaluating method that can highly accurately evaluate, based on a feature value obtained from the patterns for hole formation 21 of the resist 15, whether the hole patterns 21c formed on the film to be processed are unopened are explained below.

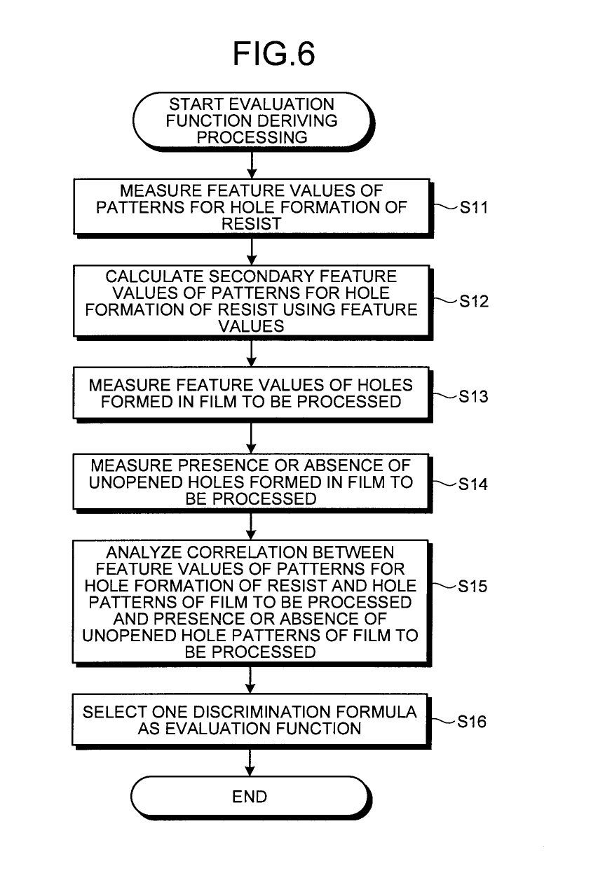

FIG. 5 is a schematic block diagram of the configuration of an evaluating apparatus according to a first embodiment. An evaluating apparatus 30 includes an input unit 31, an evaluation-function storing unit 32, a resist-pattern-data acquiring unit 33, an evaluating unit 34, a display processing unit 35, a display unit 36, and a control unit 37 that controls these units.

The input unit 31 is an input device such as a keyboard or a pointing device such as a mouse. The input unit 31 is used as an input interface by a user when the user performs evaluation of a resist pattern. For example, the user inputs, from the input unit 31, an evaluation function stored in the evaluation-function storing unit 32 and a command for causing the evaluating apparatus to execute evaluation of a resist pattern.

The evaluation-function storing unit 32 stores an evaluation function for evaluating, when the film to be processed 12 is processed by the resist 15 having the patterns for hole formation 21, whether the film to be processed is unopened. The evaluation function has, as variables (parameters), two or more feature values obtained by measuring the patterns for hole formation 21 formed in the resist 15 with the CD-SEM as explained later. The variables include at least two among hole diameters at the time when the patterns for hole formation 21 are measured at a plurality of signal threshold values, a difference of the hole diameters, and an aspect ratio as a ratio of a diameter in a long axis direction and a diameter in a direction perpendicular to the long axis concerning the patterns for hole formation 21.

The resist-pattern-data acquiring unit 33 acquires the variables used in the evaluation function stored in the evaluation-function storing unit 32, i.e., the feature values of the patterns for hole formation 21. This is performed by, for example, reading a measurement result concerning the variables designated in the evaluation function in the CD-SEM.

The evaluating unit 34 calculates an evaluation value obtained by substituting the variables (the feature values) concerning each of the patterns for hole formation 21 acquired by the resist-pattern-data acquiring unit 33 in the evaluation function stored in the evaluation-function storing unit 32. The evaluating unit 34 determines, using the evaluation value, whether the hole pattern 21c is unopened when the film to be processed 12 is processed by the resist 15 in which the pattern for hole formation 21 is formed. Specifically, when the evaluation value is not included in an error range, the evaluating unit 34 determines that the hole pattern 21c of the film to be processed 12 processed by using the pattern for hole formation 21 is opened. When the evaluation value is included in the error range, the evaluating unit 34 determines that the hole pattern 21c of the film to be processed 12 processed by using the pattern for hole formation 21 is unopened. The error range is defined as a range in which the evaluation value is smaller than zero. In other words, the evaluating unit 34 determines, when the evaluation value is equal to or larger than zero, that the hole pattern 21c of the film to be processed 12 is opened and determines, when the evaluation value is smaller than zero, that the hole pattern 21c is unopened.

The display processing unit 35 performs processing for displaying information on the display unit 36, for example, processing for displaying a determination result by the evaluating unit 34 on the display unit 36 such as a liquid crystal display device. The display unit 36 displays a determination result by the display processing unit 35 or presents necessary information to the user.

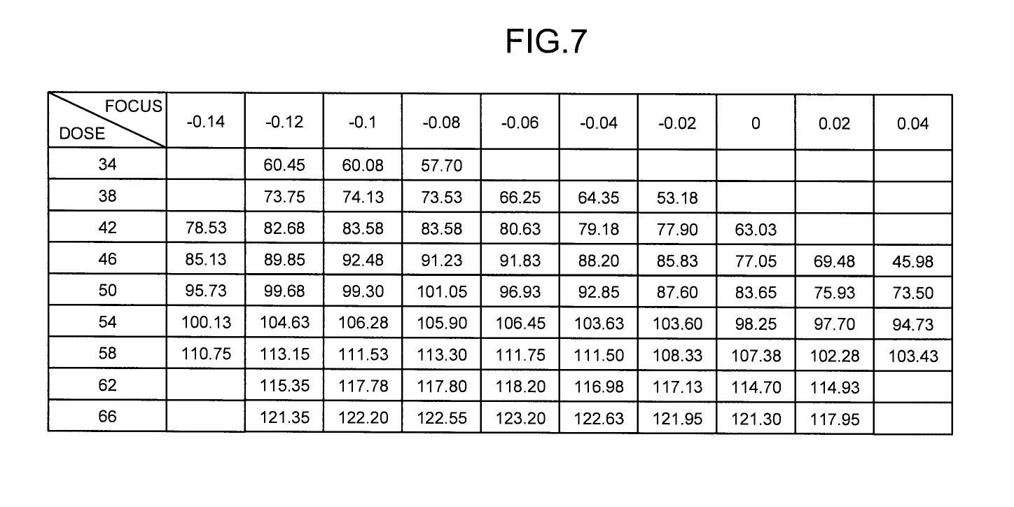

FIG. 6 is a flowchart for explaining an example of a procedure of a method of deriving an evaluation function according to the first embodiment. In deriving an evaluation function, a preliminary experiment of formation of the hole patterns 21c on the film to be processed 12 shown in FIGS. 1A to 1F is performed under conditions (e.g., the thickness of a material in use and a hole diameter) close to actual manufacturing conditions for a semiconductor device. In a process of the preliminary experiment, processing explained below is performed.

First, concerning the pattern for hole formation 21 formed in the resist 15 in FIG. 1B, feature values are measured by using the CD-SEM (step S11). Examples of feature values include a hole diameter at a predetermined signal threshold value, hole circumferential length, fluctuation in the hole diameter, and an aspect ratio of the hole diameter. In this example, the following feature values are measured:

a hole diameter at a signal threshold 20% (represented as th20);

a hole diameter at a signal threshold 50% (represented as th50);

a hole diameter at a signal threshold 80% (represented as th80);

hole circumferential length at the single threshold 50% (represented as circumference);

fluctuation in the hole diameter at the signal threshold 50% (represented as 3sigma); and

an aspect ratio of the hole diameter at the signal threshold 50% (represented as mjrmnr).

The hole diameters measured at the different signal threshold values are considered to correspond to hole diameters at respective depths of the pattern for hole formation 21. For example, the hole diameter th80 at the signal threshold 80% indicates a diameter near the top of the pattern for hole formation 21. The hole diameter th50 at the signal threshold 50% indicates a diameter near the center of the pattern for hole formation 21. The hole diameter th20 at the signal threshold 20% indicates a diameter near the bottom of the pattern for hole formation 21. The fluctuation 3sigma of the hole diameter indicates a degree of fluctuation in measured diameters in respective positions of the pattern for hole formation 21 with respect to a reference hole diameter.

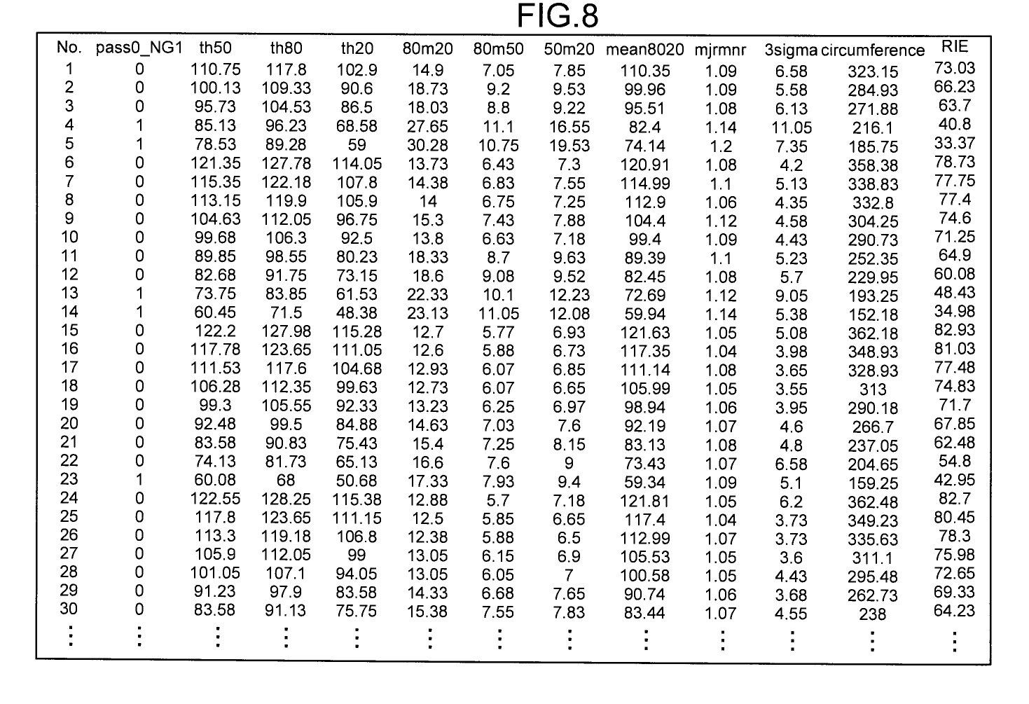

FIG. 7 is a diagram of an example of the hole diameter th50. The figure indicates the hole diameter th50 at the signal threshold 50% in the shot areas (the dose focus points) in the FEM image shown in FIG. 2. In this figure, a focus is changed in the left to right direction on the paper surface and a dose is changed in the up to down direction on the paper surface. For example, when the focus is “−0.1”, a result obtained by performing exposure while changing the dose from “34” to “66”, performing development of the shot areas, and performing measurement of the hole diameter th50 of the shot areas is described in the dose focus points.

In FIG. 7, a dose and a focus value as process parameters are changed such that the hole patterns for hole formation 21 having various feature values are formed. To fluctuate the feature values of the patterns for hole formation 21, in addition to only fluctuating the dose and the focus value, an illumination shape of an exposing device, an aperture number of the exposing device, a dimension of a photomask used in exposure, and the like can also be changed.

Subsequently, secondary feature values of the patterns for hole formation 21 are calculated by using the feature values obtained by the measurement (step S12). The secondary feature values are values obtained by performing predetermined calculation using the feature value. Examples of the secondary feature values include differences and an average of hole diameters at different signal threshold values. In this example, the following secondary feature values are calculated:

a difference of the hole diameters at the signal thresholds 80% and 20% (=th80−th20; represented as 80 m20);

a difference of the hole diameters at the signal thresholds 80% and 50% (=th80−th50); represented as 80 m50);

a difference of the hole diameters at the signal thresholds 50% and 20% (=th50−th20); represented as 50 m20); and

an average of the hole diameters at the signal thresholds 80% and 20% (=(th80+th20)/2; represented as mean8020).

The calculated differences of the hole diameters at the different signal threshold values are considered to represent tapers in sectional patterns of the resist 15. Such differences of the hole diameters are used as feature values because a risk of the hole patterns 21c formed on the film to be processed 12 not being opened is considered to increase when a hole shape changes from a vertical to a taper (compared at the same hole diameter).

Thereafter, feature values of the hole pattern 21c formed on the film to be processed 12 as shown in FIG. 1E are acquired by the CD-SEM (step S13). Examples of the feature values include a hole diameter of the hole patterns 21c of the film to be processed 12. In this example, the following feature value is acquired:

a hole diameter of the film to be processed 12 (represented as RIE).

After the hole pattern 21c is formed on the film to be processed 12 as shown in FIG. 1E, presence or absence of the unopened hole pattern 21c is checked by using the CD-SEM or, after the contact is formed in the hole pattern 21c as shown in FIG. 1F, presence or absence of the unopened hole pattern 21c is checked by the VC method (step S14).

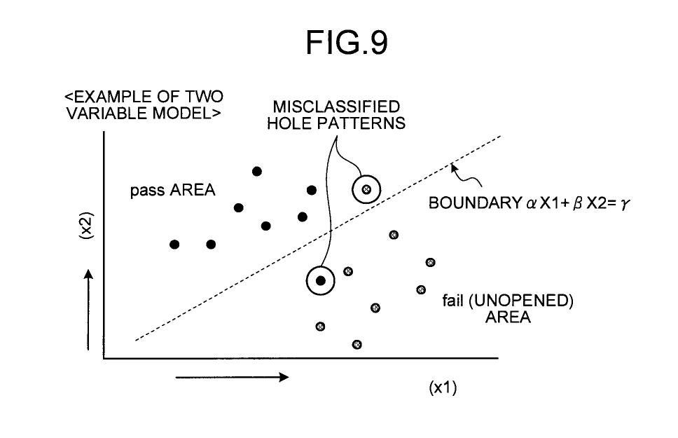

A correlation between the feature values of the pattern for hole formation 21 of the resist 15 and the hole pattern 21c of the film to be processed 12 and presence or absence of the hole pattern 21c of the film to be processed 12 is analyzed (step S15). FIG. 8 is a diagram of an example of feature values acquired for the holes. In the figure, feature values acquired for the holes in the process explained above are described. Data in one row of the figure indicates feature values of the holes in one dose focus point (shot area) shown in FIGS. 2 and 3. In the figure, only data for twenty-five rows is shown. However, actually, data for all the dose focus points (for seventy-nine rows) shown in FIG. 2, 3, or 7 is present. In the figure, an item “No.” is an identifier for identifying a dose focus point. An item “pass0_NG1” indicates presence or absence of unopened hole patterns. In the case of a shot not including an unopened hole pattern 21c, “0” is input. In the case of a shot including the unopened hole pattern 21c, “1” is input.

The correlation analysis is an analysis for obtaining a correlation between one or more feature values selected out of the feature values shown in FIG. 8 and presence or absence of the unopened hole pattern 21c of the film to be processed 12. A discrimination analysis tool used in the statistics can be used. For example, when the hole diameter th50 at the signal threshold 50% is selected as the feature value, the correlation analysis is performed by using data of the hole diameter th50 and data of presence or absence of the unopened hole pattern 21c (pass0_NG1) of the film to be processed 12. The correlation analysis is performed in the same manner when two or more feature values are selected.

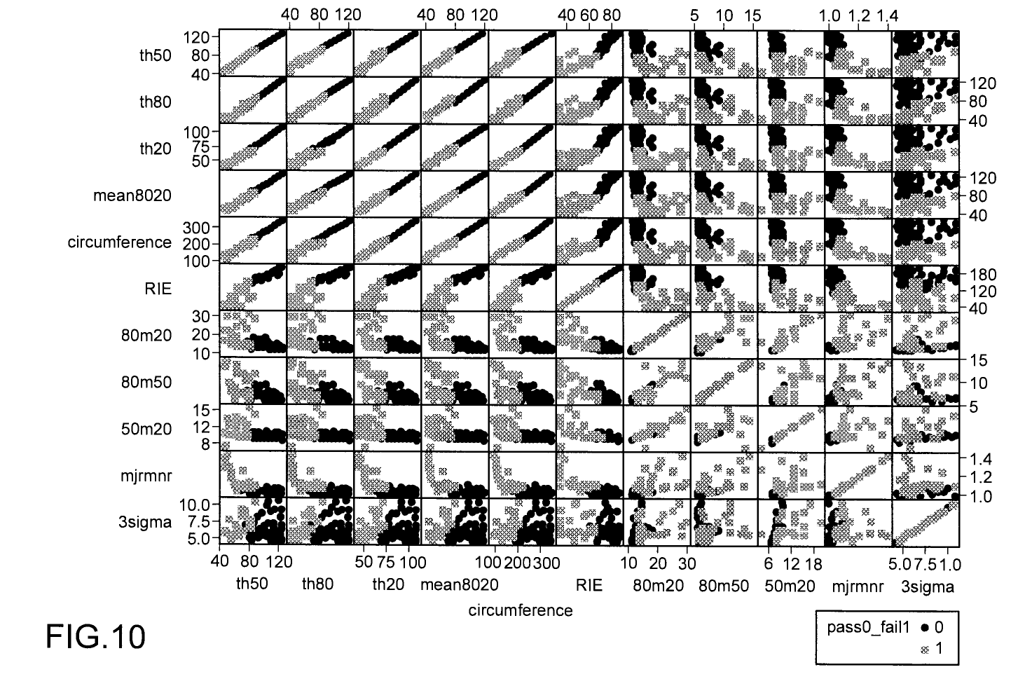

FIG. 9 is a diagram for explaining a concept of the discrimination analysis in the case of two variables.

First, in a coordinate system in which one feature value x1 is set on the abscissa and another feature value x2 is set on the ordinate, a set of data (x1, x2) shown in FIG. 8 is plotted. A boundary for classifying the opened hole patterns 21c of the film to be processed 12 and the unopened hole patterns 21c of the film to be processed 12 is obtained. An area where the opened hole patterns 21c gather is set as a pass area and an area where the unopened hole patterns 21c gather is set as a fail (unopened) area. Sets of data of the unopened hole patterns 21c present in the pass area and sets of data of the opened hole patterns 21c present in the fail area are extracted. The number of sets is acquired as a misclassification. The discrimination analysis is an analysis for obtaining a straight line that can divide the data of the opened hole patterns 21c and the data of the unopened hole patterns 21c to reduce the misclassification as much as possible. The straight line obtained in this way is a discrimination formula (an evaluation function). In this explanation, a linear function is used as a function. However, a nonlinear function including a square term can also be used. In this case, the line dividing the fail area and the pass area is a curve.

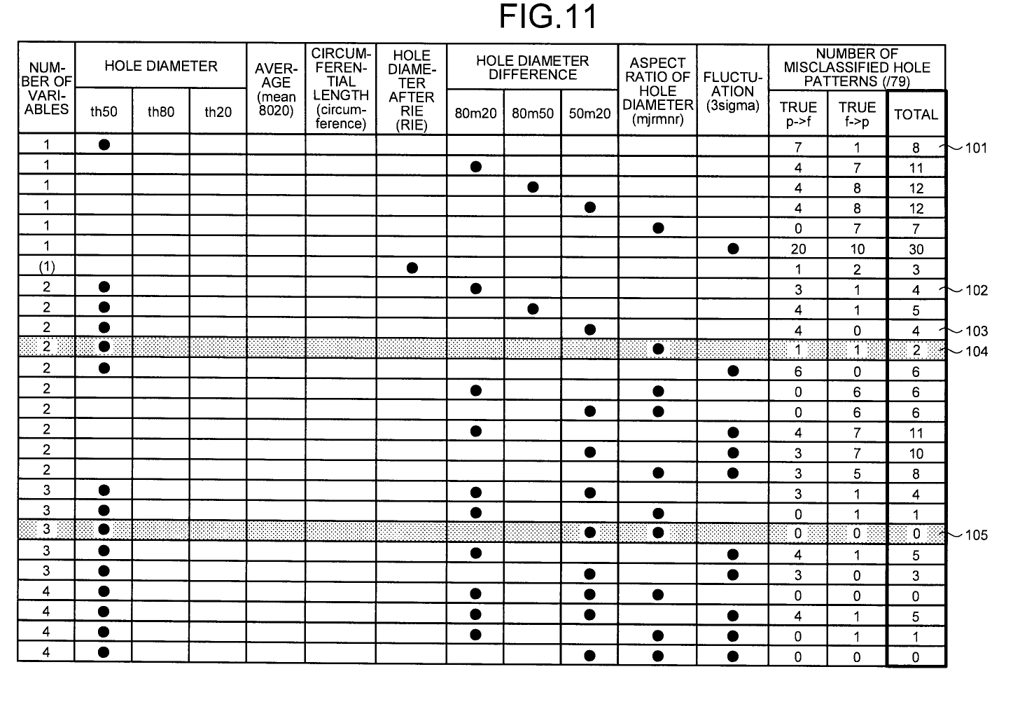

In performing the correlation analysis, it is effective to check a correlation among the feature values using a matrix scatter diagram or the like. This is because there is little merit in using both the two feature values having a too strong correlation. FIG. 10 is a diagram of an example of a matrix scatter diagram created by the two feature values shown in FIG. 8. As shown in the figure, a correlation among the hole diameters (th20, th50, and th80) of the patterns for hole formation 21, the average (mean8020) of the hole diameters, the hole circumferential length (circumference), and the hole diameter (RIE) of the hole patterns 21c of the film to be processed 12 is strong. Therefore, there is little meaning in obtaining all correlations between each of the feature values and presence or absence of the unopened hole patterns 21c of the film to be processed 12 or obtaining a correlation between two or more feature values among the feature values and presence or absence of the unopened hole patterns 21c of the film to be processed 12. Therefore, it is desirable to select one feature value to be used among the feature values. In this example, data of the hole diameter (th50) at the signal threshold 50% or the hole diameter (RIE) of the hole patterns 21c of the film to be processed 12 is used. However, this is only an example. As feature values used in the discrimination analysis, arbitrary feature values can be selected. A user can also arbitrarily select or select, based on a result obtained by using the matrix scatter diagram, feature values input to the discrimination analysis tool or the discrimination analysis tool can also capture all feature values.

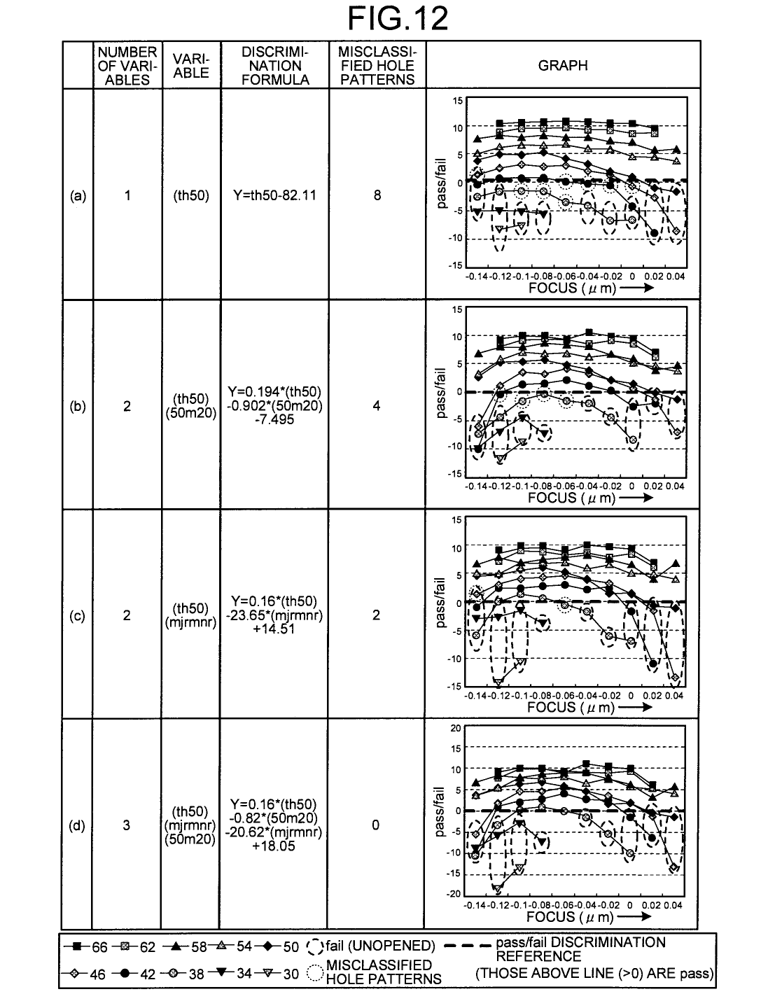

FIG. 11 is a diagram of an example of a result of the discrimination analysis between the feature values and presence or absence of the unopened hole patterns of the film to be processed. The discrimination analysis is performed when one to four feature values are used as variable. For example, a row 101 indicates that the discrimination analysis is performed by using the hole diameter th50 as a feature value. As the number of misclassified hole patterns 21c, the row 101 indicates that seven sets of data of the opened hole patterns 21c are present in the fail area (true p→f), one set of data of the unopened hole pattern 21c is present in the pass area (true f→p), and there are eight misclassified hole patterns 21c in total. A row 102 indicates that the discrimination analysis is performed by using two feature values of the hole diameter th50 and the difference of the hole diameters 80m20. The row 102 indicates that there are four misclassified hole patterns 21c.

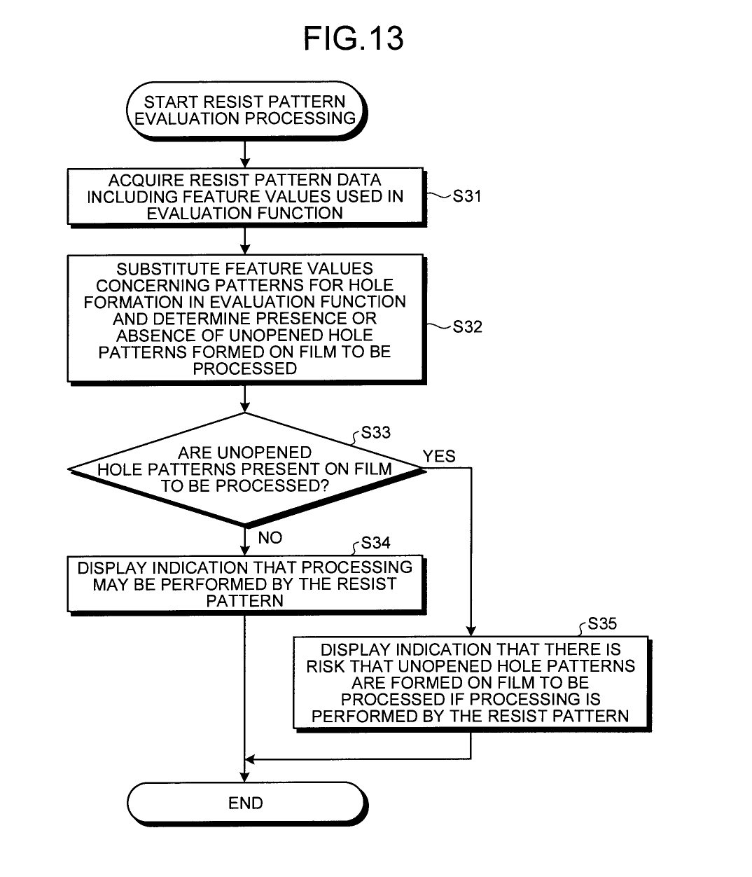

FIG. 12 is a diagram of an example of a result of the discrimination analysis. In FIG. 12, (a) indicates a result of the discrimination analysis performed by using the hole diameter th50 in the row 101 shown in FIG. 11 as one variable. (b) indicates a result of the discrimination analysis performed by using the hole diameter th50 and the hole diameter difference 50m20 in the row 103 as two variables. (c) indicates a result of the discrimination analysis performed by using the hole diameter th50 and the hole aspect ratio mjrmnr in the row 104 as two variables. (d) indicates a result of the discrimination analysis performed by using the hole diameter th50, the hole diameter difference 50m20, and the hole aspect ratio mjrmnr in the row 105 as three variables.

A discrimination formula in the figure is a formula indicating a boundary between the pass area and the fail area obtained by the discrimination analysis tool. In a graph of the figure, in a coordinate plane in which a focus value is set on the abscissa and a value of the discrimination formula is set on the ordinate, values obtained by substituting the data shown in FIG. 8 in the discrimination formula are plotted. In the discrimination formula, pass/fail≧0 indicates that the hole patterns 21c are opened and pass/fail<0 indicates that the hole patterns 21c are unopened. In the graph, points surrounded by thick broken lines indicate the unopened hole patterns 21c in actual processing. Points surrounded by thin dotted lines indicate the hole patterns 21c having different states in a result by the discrimination analysis and in actual processing.

According to the results shown in FIGS. 11 and 12, it is seen that, depending on a way of setting variables or as a larger number of variables are set, the number of misclassified hole patterns 21c decreases and a linear function of feature values selected as variables indicates a satisfactory correlation with presence or absence of unopened hole patterns. For example, in the case of two variables, when the discrimination analysis is performed by using the hole diameter th50 and the aspect ratio mjrmnr (in the case of the row 104 shown in FIG. 11 and (c) in FIG. 12), the number of misclassified hole patterns 21c is minimum two and a best result is obtained. In the case of three variables, when the discrimination analysis is performed by using the hole diameter th50, the hole diameter difference 50m20, and the aspect ratio mjrmnr (in the case of the row 105 shown in FIG. 11 and (d) in FIG. 12), the number of misclassified hole patterns 21c is minimum zero and a best result is obtained.

A discrimination formula used as an evaluation function in the evaluating apparatus 30 is selected from the results of the discrimination analysis (step S16). As the discrimination formula to be selected, a discrimination formula having a best result of the discrimination result is desirable. However, for example, when there are an extremely large number of variables used for the best discrimination formula, the discrimination formula to be selected can also be a discrimination formula not having a best result of the discrimination analysis but has an extremely small number of misclassified hole patterns 21c and an appropriate number of variables used for the discrimination formula. The discrimination formula is selected by a processing ability of the evaluating apparatus 30. As explained above, the evaluation function deriving processing ends.

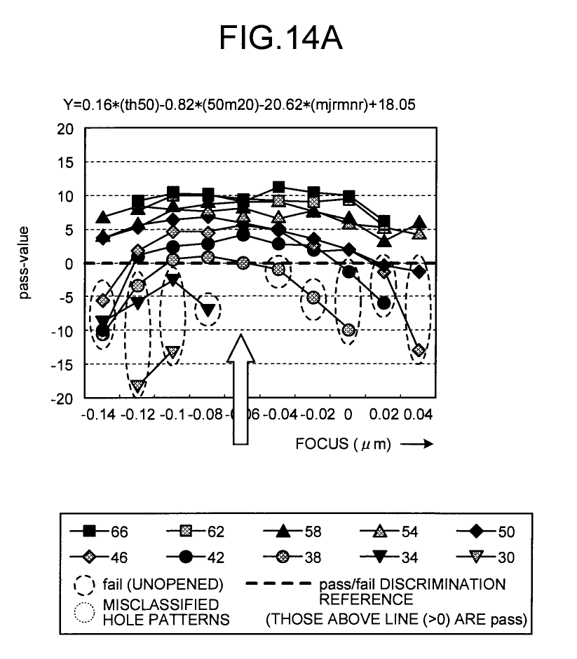

A method of evaluating patterns for hole formation formed in a resist is explained below. FIG. 13 is a flowchart for explaining an example of a procedure of a method of evaluating a resist pattern according to the first embodiment. It is assumed that, as an evaluation function matching conditions used in formation of hole patterns in a manufacturing process for an actual semiconductor device, the discrimination formula using the hole diameter th50, the hole diameter difference 50m20, and the hole aspect ratio mjrmnr as the three variables shown in (d) in FIG. 12 is already obtained and stored in the evaluation-function storing unit 32.

First, in the same manner as the procedure shown in FIGS. 1A and 1B, the film to be processed 12, the hard mask film 13, the antireflection film 14, the resist 15, and the top coat film 16 are formed on the wafer 11. Exposure and development are performed by the lithography technique to form the patterns for hole formation 21 in the resist 15. Subsequently, concerning the patterns for hole formation 21, feature values used as variables of an evaluation function are measured by using the CD-SEM. This measurement can also be performed for the respective patterns for hole formation 21 or can also be performed concerning the patterns for hole formation 21 in arbitrary positions. As the feature values, the hole diameter th50, the hole diameter difference 50m20, and the hole aspect ratio mjrmnr are measured. The measured feature values are stored as resist pattern data.

Thereafter, the resist-pattern-data acquiring unit 33 of the evaluating apparatus 30 acquires resist pattern data as feature values of the patterns for hole formation 21 of the resist measured by the CD-SEM (step S31). The resist-pattern-data acquiring unit 33 acquires the resist pattern data by reading a storage medium having the resist pattern data stored therein with the CD-SEM, reading the resist pattern data stored in the CD-SEM via a communication line, or reading feature values input via the input unit 31.

The evaluating unit 34 substitutes the feature values concerning the patterns for hole formation 21 of the resist pattern data acquired by the resist-pattern-data acquiring unit 33 in the parameters of the evaluation function stored in the evaluation-function storing unit 32, performs calculation, and evaluates whether the hole patterns 21c formed on the film to be processed 12 when processing is performed by using the patterns for hole formation 21 is unopened (step S32). This evaluation is performed for all the read resist pattern data.

Thereafter, the evaluating unit 34 determines whether there are the hole patterns 21c evaluated as unopened among the hole patterns 21c formed on the film to be processed 12 (step S33). When there is no unopened hole pattern 21c (“No” at step S33), the display processing unit 35 displays, on the display unit 36, indication that processing may be performed by the resist 15 having the patterns for hole formation 21 formed on the film to be processed 12 (step S34) and the processing ends. Thereafter, the user performs processing of the film to be processed 12 using the developed resist 15 and advances the manufacturing processing for the semiconductor device.

On the other hand, when there are unopened hole patterns 21c (“Yes” at step S33), the display processing unit 35 displays, on the display 36, indication that there is a risk that the unopened hole patterns 21c are formed on the film to be processed 12 when processing is performed by the resist 15 formed on the film to be processed 12 (step S35). The display unit 36 outputs a warning and the processing ends. Thereafter, the user strips the developed resist 15 from the wafer 11, forms a resist pattern on the same wafer 11 again, and repeats the processing explained above until it is determined that the unopened hole patterns 21c are not formed on the film to be processed 12.

In the first embodiment, the evaluation function for discriminating presence or absence of the unopened hole patterns 21c formed on the film to be processed 12 is formed by using the feature values concerning the patterns for hole formation 21 of the resist 15 or the hole patterns 21c of the film to be processed 12 or the two or more secondary feature values obtained from the feature values. This makes it possible to more highly accurately determine presence or absence of the unopened hole patterns 21c of the film to be processed 12 compared with determining presence or absence of the unopened hole patterns 21c of the film to be processed 12 using only one feature value concerning the patterns for hole formation 21 of the resist 15.

It is also possible to acquire resist pattern data including feature values of the patterns for hole formation 21 of the resist 15 formed in a manufacturing process for an actual semiconductor device and determine, using the acquired resist pattern data and the evaluation function, whether the film to be processed 12 can be processed not to cause the unopened hole patterns 21c on the film to be processed 12. As a result, when it is determined that the unopened hole patterns 21c are caused, it is sufficient to strip only the resist 15 before processing the wafer 11, apply the resist 15 again, and form a resist pattern. Therefore, there is an effect that a wafer loss is not caused.

In the first embodiment, when the film to be processed is processed by using the patterns for hole formation of the resist, it is evaluated whether unopened hole patterns are formed. In a second embodiment, an exposure condition is obtained by using the evaluation function (the discrimination formula) used in the first embodiment.

In determining an exposure condition used in actual device manufacturing, it is important to accurately determine the center of a focus. This is because, if the center of the focus is deviated, a risk of occurrence of unopened hole patterns increases because of fluctuation in the focus. In the first embodiment, as shown in FIG. 12, when the focus is set on the abscissa and the evaluation values by the discrimination formula are plotted, the result of the discrimination analysis partially having an upward projecting shape is obtained. Therefore, it is possible to reduce the risk of occurrence of unopened hole patterns due to the fluctuation in the focus by adopting this upward projecting section, i.e., a focus values having a local maximum is adopted as an exposure condition.

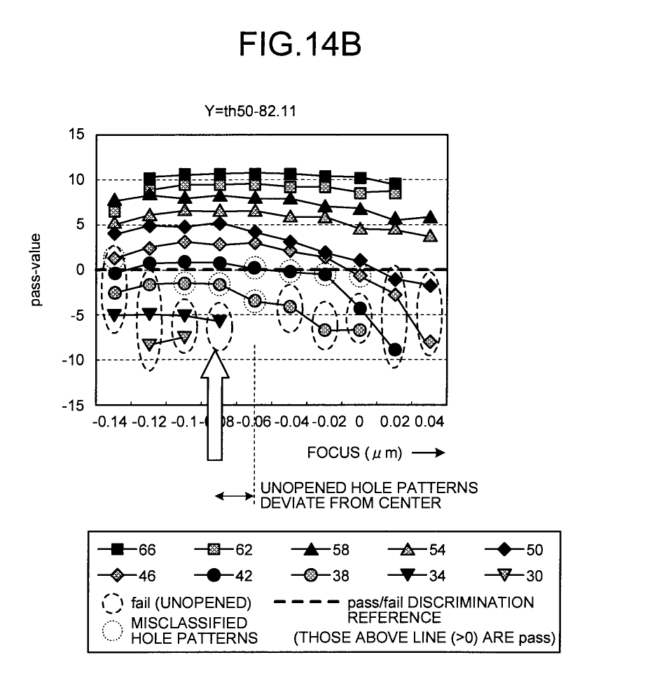

FIGS. 14A and 14B are diagrams for explaining an example of a method of obtaining an exposure condition from an evaluation function. In FIG. 14A, discrimination is performed by using the hole diameter th50, the hole diameter difference 50m20, and the aspect ratio mjrmnr as parameters. FIG. 14A is the same as the graph shown in (a) in FIG. 12. In FIG. 14B, discrimination is performed by using only the hole diameter th50 as a parameter. As in FIG. 12, the abscissa of the graph indicates a focus during formation of patterns for hole formation of a resist and the ordinate indicates an evaluation value by an obtained discrimination formula (evaluation function).

In the case of FIG. 14A, −0.06 micrometer at which the evaluation value is a maximum (local maximum) in a focus direction is selected as a focus center. Therefore, the focus is fixed to −0.06 micrometer, twenty-five wafers are exposed and processed in a process same as the process in the first embodiment under a condition that a dose is fixed to the center condition, and the hole patterns 21c are formed on the film to be processed 12. The hole patterns 21c were observed by the CD-SEM to find the unopened hole patterns 21c. However, no unopened hole pattern 21c was found.

On the other hand, in the case of FIG. 14B, −0.08 micrometer at which the evaluation value (the hole diameter th50) is a maximum (local maximum) is selected as a focus center. Therefore, the focus is fixed to −0.08 micrometer, twenty-five wafers are exposed and processed in a process same as the process in the first embodiment under a condition that a dose is fixed to the center condition, and the hole patterns 21c are formed on the film to be processed 12. The hole patterns 21c of the film to be processed 12 were observed by the CD-SEM to find the unopened hole patterns 21c. The unopened hole patterns 21c were found in several shots. This is because the value of the focus center deviates from the value (−0.06 micrometer) of the focus center in the case of FIG. 14A.

According to the second embodiment, there is an effect that an exposure condition can be obtained by using the evaluation function used for determination of presence or absence of the unopened hole patterns 21c formed on the film to be processed 12.

In the first embodiment, it is determined from the evaluation value calculated by using the evaluation function concerning the patterns for hole formation formed in the resist whether unopened hole patterns are formed on the film to be processed. In a third embodiment, an evaluating apparatus is explained that, when an exposure condition is fixed, detects abnormality of an exposing device from an evaluation value obtained by using an evaluation function concerning patterns for hole formation formed in a resist.

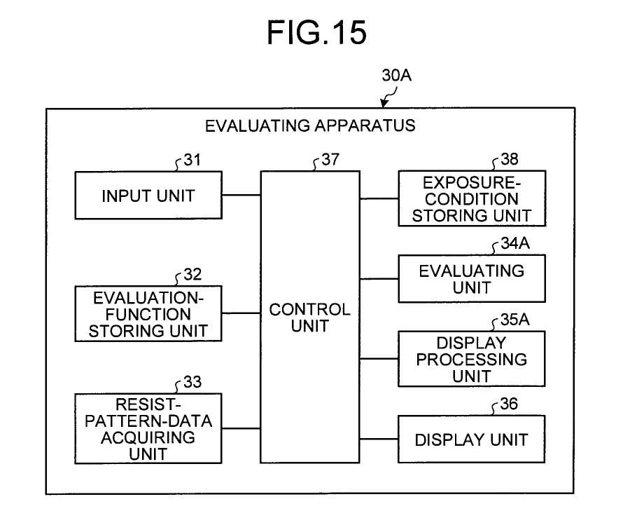

FIG. 15 is a schematic block diagram of an example of the configuration of an evaluating apparatus according to the third embodiment. An evaluating apparatus 30A used in the third embodiment further includes an exposure-condition storing unit 38 in addition to the units of the evaluating apparatus 30 shown in FIG. 5 in the first embodiment. The exposure-condition storing unit 38 stores an exposure condition selected by the method explained in the second embodiment. For example, a user inputs the exposure condition via the input unit 31. When the exposure condition is input to the exposure-condition storing unit 38, an evaluating unit 34A determines whether a state of the exposing device is appropriate.

The evaluating unit 34A further has a function of determining, when the exposure condition is input to the exposure-condition storing unit 38, whether a state of the exposing device is appropriate using an evaluation value of patterns for hole formation of resists evaluated by using the evaluation function stored in the evaluation-function storing unit 32. For example, the evaluation value is equal to or larger than zero, the evaluating unit 34A determines that the exposing device is normal. When the evaluation value is smaller than zero, the evaluating unit 34A determines that abnormality occurs in the exposing device.

A display processing unit 35A further has a condition of displaying, when the exposure condition is input to the exposure-condition storing unit 38 and the evaluating unit 34A determines that abnormality occurs in the exposing device, indication that the abnormality occurs in the exposing device on the display unit 36. Components same as those in the first embodiment are denoted by the same reference numerals and signs and explanation of the components is omitted.

A method of determining occurrence of abnormality of the exposing device using the evaluating apparatus 30A having such a configuration is the same as the method of determining whether unopened hole patterns are formed on the film to be processed in the first embodiment. A specific example of a method of determining occurrence of abnormality of the exposing device using the evaluating apparatus 30A according to the third embodiment is explained below.

The function shown in FIG. 14A in the second embodiment is selected as an evaluation function, −0.06 micrometer shown in FIG. 14A in the second embodiment is selected as a focus center of an exposure condition, and a dose is fixed to 54 millijoules. These exposure conditions are stored in the exposure-condition storing unit 38.

In such a state, as in the first embodiment, twenty-five wafers are exposed and processed. When hole patterns of a film to be processed were formed and observed by the CD-SEM, no unopened hole pattern was found. It is assumed that, concerning a first wafer, an evaluation value obtained as a result of measuring feature values of patterns for hole formation formed in a resist was 8.0.

Thereafter, the wafers are fed in lot units and processed. In each of the lots, after a resist pattern is formed, feature values same as those shown in FIG. 14A in the second embodiment, i.e., the hole diameter th50, the hole diameter difference 50m20, and the aspect ratio mjrmnr are measured and an evaluation value is calculated by using the evaluation function. It is assumed that the evaluation value indicates values between 7.5 and 8.5 up to a forty-ninth lot. As a result, the evaluating unit 34A determines that the exposing device is not abnormal.

However, it is assumed that the evaluation value indicated a value −1.0 smaller than zero in a fiftieth lot. Therefore, the evaluating unit 34A determines that a risk of unopened hole patterns formed on the film to be processed increases (or the exposing device is abnormal). The display processing unit 35A outputs warning to the display unit 36. The feeding of the lots was suspended according to the warning and a cause of the unopened hole patterns was investigated. As a result of the investigation, it was found that a focus of the exposing device deviated due to some cause. This deviation can be eliminated by repairing the exposing device.

By warning that the abnormality occurs in the exposing device, it is possible to prevent the lots from being fed while the exposing device remains abnormal. Concerning the (defocused) wafer of the fiftieth lot, the resist is once stripped and the resist is applied again. The wafer is exposed and developed by the repaired exposing device and reused. Thereafter, when feature values same as those shown in FIG. 14A were measured and an evaluation value was calculated, the evaluation value was 8.0. Therefore, the lots can be fed without a problem next time. Consequently, it is possible to prevent a loss of wafers.

In this embodiment, the exposure-condition storing unit 38 is provided and, when an exposure condition is stored in the exposure-condition storing unit 38, a state of the exposing device is determined. However, the present invention is not limited to this. For example, the determination of a state of the exposing device can also be simply performed. The determination of a state of the exposing device and the determination concerning whether unopened hole patterns are formed on the film to be processed can also be switched by a switch. As in the first embodiment, a result of the determination concerning whether unopened hole patterns are formed on the film to be processed can also be directly used for the determination concerning whether a state of the exposing device is abnormal.

In the above explanation, the exposing device is determined as abnormal when a value of the evaluation function is smaller than zero. However, for example, it is also possible to set a range of values of the evaluation function usually obtained from an exposure condition is set (in the example explained above, 7.5 to 8.5) and, when a value of the evaluation functions is a value smaller than the set range, determine that abnormality occurs in the exposing device.

According to the third embodiment, in a manufacturing process for a semiconductor device as an actual product, an evaluation value of the patterns for hole formation of the resist is calculated by using the evaluation function and, when the evaluation value is smaller than a predetermined value, notification indicating that abnormality occurs in the exposing device is output. Therefore, there is an effect that not only a risk formed the unopened hole patterns of the film to be processed but also abnormality of the exposing device can be determined.

The evaluating method for evaluating, using the patterns for hole formation formed in the resist, presence or absence of unopened hole patterns formed on the film to be processed or presence or absence of occurrence of abnormality of the exposing device explained in the embodiments can also be implemented as a computer program product for causing a computer to execute the evaluating method. The computer program product for causing the computer to execute the evaluating method is provided while being recorded in a computer-readable recording medium such as a compact disk read only memory (CD-ROM), a floppy (registered trademark) disk, or a digital versatile disc or a digital video disc (DVD) as a file of an installable format or an executable format. The computer program product for causing the computer to execute the evaluating method explained in the embodiments can also be stored on a computer connected to a network such as the Internet and provided by being downloaded through the network.

By implementing the evaluating method as the computer program product for causing the computer to execute the evaluating method in this way, the evaluating apparatus 30 or 30A can include an information processing apparatus such as a personal computer including an arithmetic unit such as a central processing unit (CPU), a storing unit such as a read only memory (ROM) or a random access memory (RAM), an external storage unit such as a hard disk drive (HDD) or a CD-ROM drive device, a display unit such as a display device, and an input unit such as a keyboard or a mouse and, if necessary, a network interface unit such as a network board. In this case, the evaluating method is performed by expanding the computer program product for causing the computer to execute the evaluating method installed in the external storage device on the storing unit such as the RAM and executing the computer program product in the arithmetic unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An evaluating apparatus that evaluates, when a processing target is processed by using a resist pattern formed on the processing target, presence or absence of a risk that a hole pattern formed on the processing target is unopened, the evaluating apparatus comprising:
a resist-pattern-data acquiring unit that acquires resist pattern data having a plurality of feature values including at least two among a hole diameter at a predetermined signal threshold measured concerning a pattern for hole formation in the resist pattern, an aspect ratio of the hole diameter, and a difference of hole diameters at a plurality of signal thresholds; and
an evaluating unit that substitutes the acquired resist pattern data in parameters of an evaluation function, which includes the feature values as the parameters, for evaluating the presence or absence of the risk that the hole pattern formed on the processing target by using the pattern for hole formation is unopened, calculates an evaluation value concerning the pattern for hole formation, and evaluates, based on the evaluation value, the presence or absence of the risk that the hole pattern is unopened.

2. The evaluating apparatus according to claim 1, further comprising a display processing unit that displays, when the evaluating unit evaluates that there is a risk formed the unopened hole pattern, a result of the evaluation on a display unit.

3. The evaluating apparatus according to claim 1, wherein the evaluating unit is configured to further determine, when the evaluation value is smaller than a predetermined range, that abnormality occurs in an exposing device that exposes the resist pattern on the processing target.

4. The evaluating apparatus according to claim 3, further comprising an exposure-condition storing unit that stores an exposure condition used by the exposing device during formation of the pattern for hole formation, wherein
the evaluating unit performs, when the exposure condition is stored in the exposure-condition storing unit, processing for determining occurrence of abnormality of the exposing device.

5. The evaluating apparatus according to claim 4, wherein the exposure condition stored in the exposure-condition storing unit is, when each of evaluation values calculated from the evaluation function for a plurality of patterns for hole formation formed by changing the exposure condition and having the feature values different from one another is a function of the exposure condition, an exposure condition under which the evaluation value is a local maximum.

6. The evaluating apparatus according to claim 5, wherein the exposure condition is a focus value.

7. The evaluating apparatus according to claim 1, wherein the evaluation function is a linear function or a nonlinear function of the feature values obtained by classifying, according to the feature values, whether hole patterns actually formed on the processing target by using a plurality of patterns for hole formation having the feature values different from one another are unopened.

8. An evaluating method for evaluating, when a processing target is processed by using a resist pattern formed on the processing target, presence or absence of a risk that a hole pattern formed on the processing target is unopened, the evaluating method comprising:
preparing an evaluation function for evaluating the presence or absence of the risk that the hole pattern formed on the processing target by using a pattern for hole formation in the resist pattern is unopened, the evaluation function including a plurality of feature values including at least two among a hole diameter at a predetermined signal threshold, an aspect ratio of the hole diameter, and a difference of hole diameters at a plurality of signal thresholds as parameters concerning the pattern for hole formation;
measuring the feature values used as the parameters in the evaluation function concerning the pattern for hole formation;
acquiring the feature values as resist pattern data; and
substituting the acquired resist pattern data in the parameters of the evaluation function, calculating an evaluation value concerning the pattern for hole formation, and evaluating, based on the evaluation value, the presence or absence of the risk that the hole pattern is unopened.

9. The evaluating method according to claim 8, further comprising outputting an evaluation result of the presence or absence of the risk that the hole pattern is unopened.

10. The evaluating method according to claim 9, wherein the outputting an evaluation result includes outputting a warning when there is a risk that the unopened hole pattern is present.

11. The evaluating method according to claim 8, further comprising determining, when the evaluation value is smaller than a predetermined range, that abnormality occurs in an exposing device that exposes the resist pattern on the processing target.

12. The evaluating method according to claim 8, wherein the evaluation function is a linear function or a nonlinear function of the feature values obtained by classifying, according to the feature values, whether hole patterns actually formed on the processing target by using a plurality of patterns for hole formation having the feature values different from one another are unopened.

13. The evaluating method according to claim 12, wherein the patterns for hole formation having the feature values different from one another are formed by changing an exposure condition.

14. The evaluating method according to claim 13, wherein the exposure condition includes at least one of a dose, a focus value, an illumination shape, an aperture number, and a dimension of a photomask.

15. The evaluating method according to claim 13, wherein, when each of evaluation values calculated from the evaluation function for the patterns for hole formation having the feature values different from one another is a function of the exposure condition, an exposure condition under which the evaluation value is a local maximum is used as an exposure condition during actual formation of the pattern for hole formation.

16. A computer program product executable by a computer and including a plurality of commands for evaluating, when a processing target is processed by using a resist pattern formed on the processing target, presence or absence of a risk that a hole pattern formed on the processing target is unopened, the commands causing the computer to execute:
preparing an evaluation function for evaluating the presence or absence of the risk that the hole pattern formed on the processing target by using a pattern for hole formation in the resist pattern is unopened, the evaluation function including a plurality of feature values including at least two among a hole diameter at a predetermined signal threshold, an aspect ratio of the hole diameter, and a difference of hole diameters at a plurality of signal thresholds as parameters concerning the pattern for hole formation;
measuring the feature values used as the parameters in the evaluation function concerning the pattern for hole formation;
acquiring the feature values as resist pattern data; and
substituting the acquired resist pattern data in the parameters of the evaluation function, calculating an evaluation value concerning the pattern for hole formation, and evaluating, based on the evaluation value, the presence or absence of the risk that the hole pattern is unopened.

17. The computer program product according to claim 16, further causing the computer to execute outputting an evaluation result of the presence or absence of the risk that the hole pattern is unopened.

18. The computer program product according to claim 17, wherein the outputting an evaluation result includes outputting a warning when there is a risk that the unopened hole pattern is present.

19. The computer program product according to claim 16, further causing the computer to execute determining, when the evaluation value is smaller than a predetermined range, that abnormality occurs in an exposing device that exposes the resist pattern on the processing target.

20. The computer program product according to claim 16, wherein the evaluation function is a linear function or a nonlinear function of the feature values obtained by classifying, according to the feature values, whether hole patterns actually formed on the processing target by using a plurality of patterns for hole formation having the feature values different from one another are unopened.
